(19) United States
(12) Patent Application Publication
(10) Pub. No.: US 2014/0278302 A1
(43) Pub. Date: Sep. 18, 2014

(54) COMPUTER-IMPLEMENTED METHOD, A DEVICE, AND A COMPUTER-READABLE MEDIUM FOR DATA-DRIVEN MODELING OF OIL, GAS, AND WATER

(71) Applicants: Eric Ziegel, Houston, TX (US); Shahryar Shirzadi, Katy, TX (US); Richard Heddle, Camberley (GB); Richard Bailey, Ashtead Surrey (GB); Carl Cook, Minneapolis, MN (US)

(72) Inventors: Eric Ziegel, Houston, TX (US); Shahryar Shirzadi, Katy, TX (US); Richard Heddle, Camberley (GB); Richard Bailey, Ashtead Surrey (GB); Carl Cook, Minneapolis, MN (US)

(21) Appl. No.: 14/210,107

(22) Filed: Mar. 13, 2014

Related U.S. Application Data
(60) Provisional application No. 61/779,652, filed on Mar. 13, 2013.

(51) Int. Cl. G06F 17/50

(52) U.S. Cl. CPC G06F 17/5009
USPC 703/2; 703/9

(57) ABSTRACT

A method for independently modeling a water flow rate, an oil flow rate, and a gas flow rate using data-driven computer models is disclosed. The method can include obtaining parameters of a well associated with an asset during a well test; creating the ensemble of data-driven models to model the water flow rate, the oil flow rate, and the gas flow rate based on the parameters; evaluating each model of the ensemble of models; selecting a subset of models from the ensemble of models; modeling each of the water flow rate, the oil flow rate, and the gas flow rate independently using the subset of models; reconciling each of the water flow rate, the oil flow rate, and the gas flow rate for the well with a total flow rate at the asset; and outputting the water flow rate, the oil flow rate, and the gas flow rate.

### CROSS-REFERENCE TO RELATED APPLICATIONS

This application claims priority to U.S. Provisional Patent Application No. 61/779,652, filed on Mar. 13, 2013, which is hereby incorporated by reference in its entirety.

### STATEMENT REGARDING FEDERALLY SPONSORED RESEARCH OR DEVELOPMENT

Not applicable.

### FIELD

This disclosure is in the field of fluid flow calculations, and is more specifically directed to data-driven modeling of gas, water, and oil flow.

### BACKGROUND

During oilfield operations, data is typically collected for analysis and/or monitoring of the oilfield operations. Such data may include, for example, data reflecting subterranean formation, equipment, historical and/or other data. Data concerning the subterranean formation is collected using a variety of sources. Such formation data may be static or dynamic. Static data relates to, for example, formation structure and geological stratigraphy that define the geological structures of the subterranean formation. Dynamic data relates to, for example, fluids flowing through the geologic structures of the subterranean formation over time. Such static and/or dynamic data may be collected to learn more about the formations and the valuable assets contained therein.

Data from one or more wellbores may be analyzed to plan or predict various outcomes at a given wellbore. In some cases, the data from neighboring wellbores, or wellbores with similar conditions or equipment may be used to predict how a well will perform. There are usually a large number of variables and large quantities of data to consider in analyzing oilfield operations. It is, therefore, often useful to model the behavior of the oilfield operation to determine the desired course of action. During the ongoing operations, the operating parameters may adjust as oilfield conditions change and new information is received.

One example aspect of oilfield operations is to monitor fluid flow rates. In many oil production operations, where oil is produced from underground reservoirs, various fluids are injected into the reservoirs to increase recovery of oil. The injected fluids increase oil recovery by providing increased pressure support for the extraction of oil, or by displacing the oil toward the wells. Typical fluids injected into the reservoirs for improved oil recovery operations include water or hydrocarbon gas where each injection well may furthermore have multiple injection zones or branches for which the injection flow into each zone and/or branch is to be monitored and controlled.

Additionally, in many oil production operations, effluents are produced as by-products of the oil and gas extraction process, and such waste effluents are disposed of by injection into reservoirs via disposal wells. Typically, the effluents disposed into underground reservoirs include excess produced water or carbon dioxide. The reliability of such disposal operations is often critical for the simultaneous oil and gas production process. Similarly, injection wells are also found in underground storage operations in which hydrocarbon gas is stored in underground locations.

In conventional practice, injection wells are often equipped at the surface with single phase flow meters and pressure measurements. However, flow meters are susceptible to drift in accuracy or of complete failure. For example, water flow meters tend to scale up. It is not abnormal in the field for the sum of individual water meter measurements to be very significantly different from the measurement of the total water flow before distribution to the individual wells. Similarly, it is desirable to provide a method for validation and reconciliation of the injection flows or estimates. Also, in the case of injection wells with multiple injection zones and/or branches, it is in general problematic to provide subsurface flow meters to measure injection flows into individual zones and/or branches.

Accordingly, an improved technique for estimating oil, gas, and, water flow for oil field operation is needed.

### SUMMARY

In implementations, a computer-implemented method for autonomously and independently modeling a water flow rate, an oil flow rate, and a gas flow rate of a well associated with an asset comprising one or more wells using an ensemble of data-driven computer models is disclosed. The computer-implemented method can comprise automatically obtaining one or more parameters of the well as measured by one or more sensors at one or more of a well bore, a well head, and one or more flow lines to a separator associated with the well during a well test; using the ensemble of data-driven computer models to independently model the water flow rate, the oil flow rate, and the gas flow rate based on the one or more parameters; evaluating each data-driven computer model of the ensemble of data-driven computer models based on historic, current, or both historic and current conditions; selecting a subset of data-driven computer models from the ensemble of data-driven computer models that were evaluated to independently model the water flow rate, the oil flow rate, and the gas flow rate based on the one or more parameters; modeling each of the water flow rate, the oil flow rate, and the gas flow rate independently using the subset of data-driven computer models; and automatically reconciling each of the water flow rate, the oil flow rate, and the gas flow rate that was independently modeled for the well with a total flow rate obtained at the asset; outputting each of the water flow rate, the oil flow rate, and the gas flow rate based on the modeling and outputting the each of the water flow rate, the oil flow rate, and the gas flow rate based on the reconciling.

In implementations, the one or more parameters comprise one or more of: a well head pressure that is measured at a discharge portion of a well before a choke, a well head temperature that is measured at a discharge portion of a well before a choke, a casing pressure that is a measure of a pressure on a casing of a well caused by injected gas in a gas lift injected well, a flow line pressure is a measure of pressure of a production measured after a choke, and an amount of choke.

In implementations, the ensemble of data-driven computer models comprise one or more of: a neural network models, non-linear regression models, fuzzy rule-based models, genetic algorithms, evolutionary algorithms, chaos theory, non-linear dynamics, and support vector machines.

In implementations, the method can further include applying one or more statistical algorithms to prepare the one or more parameters for modeling.

In implementations, the method can further include determining that one or more values in the one or more parameters is outside a predetermined threshold and removing the one or more values that were determined to be outside the predetermined threshold.

In implementations, the method can further include modeling a confidence interval for each of the oil flow rate, gas flow rate, and water flow rate.

In implementations, the method can further comprise determining that the oil flow rate, the gas flow rate, or the water flow rate that was modeled is unreliable; and providing a recommendation that a new well test is needed based on the determination.

In implementations, the determining that the oil flow rate, the gas flow rate, or the water flow rate that was modeled is unreliable can be based on information from one or more process historians.

In implementations, the method can further comprise determining that the new well test should occur prior to new well test for other wells associated with the asset.

In implementations, the method can further comprise determining that one or more parameters from the one or more sensors at the is missing, corrupt, out of an expected range, or combinations therein; and removing the one or more parameters that were determined to be missing, corrupt, out of an expected range as an input to the ensemble of data-driven models.

In implementations, the method can further comprise determining that the oil flow rate, the gas flow rate, or the water flow rate that was modeled does not match with physical data obtained at the well; modifying the oil flow rate, the gas flow rate, or the water flow rate based on the physical data that was obtained.

In implementations, the method can further comprise determining that one or more of the parameters obtained during the well test is not valid; and automatically producing a new well model based on the one or more of the parameters that are valid.

In implementations, the method can further comprise determining that another well test is being performed for another well associated with the asset during the well test; and dividing the total flow rates for the asset for the well and the another well that are undergoing well tests.

In implementations, both the outputting occurs at different time periods. For example, the estimates of the rates from the numerical modes can occur every 15 minutes and the reconciled outputs can occur every hour.

In implementations, the method can further comprise automatically producing updated water flow rate, oil flow rate, and gas flow rate estimates after determining that the one or more parameters are outside of a valid date range.

In implementations, a system is disclosed that can include one or more processors; and a non-transitory computer readable medium comprising instructions that cause the one or more processors to perform a method a computer-implemented method for autonomously and independently modeling a water flow rate, an oil flow rate, and a gas flow rate of a well associated with an asset comprising one or more wells using an ensemble of data-driven computer models is disclosed. The computer-implemented method can comprise automatically obtaining one or more parameters of the well as measured by one or more sensors at one or more of a well bore, a well head, and one or more flow lines to a separator associated with the well during a well test; using the ensemble of data-driven computer models to independently model the water flow rate, the oil flow rate, and the gas flow rate based on the one or more parameters; evaluating each data-driven computer model of the ensemble of data-driven computer models based on historic, current, or both historic and current conditions; selecting a subset of data-driven computer models from the ensemble of data-driven computer models that were evaluated to independently model the water flow rate, the oil flow rate, and the gas flow rate based on the one or more parameters; modeling each of the water flow rate, the oil flow rate, and the gas flow rate independently using the subset of data-driven computer models; and automatically reconciling each of the water flow rate, the oil flow rate, and the gas flow rate that was independently modeled for the well with a total flow rate obtained at the asset; outputting each of the water flow rate, the oil flow rate, and the gas flow rate based on the modeling and outputting the each of the water flow rate, the oil flow rate, and the gas flow rate based on the reconciling.

In implementations, a non-transitory computer readable storage medium comprising instructions that cause one or more processors to perform a method for autonomously and independently modeling a water flow rate, an oil flow rate, and a gas flow rate of a well associated with an asset comprising one or more wells using an ensemble of data-driven computer models is disclosed. The computer-implemented method can comprise automatically obtaining one or more parameters of the well as measured by one or more sensors at one or more of a well bore, a well head, and one or more flow lines to a separator associated with the well during a well test; using the ensemble of data-driven computer models to independently model the water flow rate, the oil flow rate, and the gas flow rate based on the one or more parameters; evaluating each data-driven computer model of the ensemble of data-driven computer models based on historic, current, or both historic and current conditions; selecting a subset of data-driven computer models from the ensemble of data-driven computer models that were evaluated to independently model the water flow rate, the oil flow rate, and the gas flow rate based on the one or more parameters; modeling each of the water flow rate, the oil flow rate, and the gas flow rate independently using the subset of data-driven computer models; and automatically reconciling each of the water flow rate, the oil flow rate, and the gas flow rate that was independently modeled for the well with a total flow rate obtained at the asset; outputting each of the water flow rate, the oil flow rate, and the gas flow rate based on the modeling and outputting the each of the water flow rate, the oil flow rate, and the gas flow rate based on the reconciling.

### BRIEF DESCRIPTION OF THE DRAWINGS

FIG. 1 is a schematic diagram of an example of a production field in connection with which the embodiments of the disclosure may be used.

FIG. 2 is an exemplary diagram, in block form, of a data-driven modeling system programmed to carry out an embodiment of the disclosure.

FIG. 3 is a flow diagram illustrating an example method for data-driven modeling of oil, water, and gas flow rates in a well according to an embodiment of the disclosure.

FIG. 4 shows a comparison between the “Sum of Estimates vs. Sum of Platform Meters” metrics during the evaluation period according to some embodiments.

FIG. 5 shows an example plot of DD-FVM system estimates for gas according to some embodiments.

FIG. 6 shows a comparison plot of DD-FVM Estimated water and production management advisory system estimated water according to some embodiments.

FIG. 7 shows a table with the result of the well tests during the evaluation period according to some embodiments.

FIG. 8 shows a trend chart showing indicators that wells are operating outside of prior well test values according to some embodiments.

FIG. 9 shows a data grid showing that wells W03, W10, W14, and W16 are showing well test suggestions according to some embodiments.

FIG. 10 is a graph showing a confidence interval with a 30 period smoothing applied for well oil flow estimates for well W16 according to some embodiments.

FIG. 11 is a graph showing the oil flow estimates for the evaluation period for well W01 according to some embodiments.

FIG. 12 is a graph showing the oil flow estimates for the evaluation period for well W03 according to some embodiments.

FIG. 13 is a graph showing the oil flow estimates for the evaluation period for well W06 according to some embodiments.

FIG. 14 is a graph showing the oil flow estimates for the evaluation period for well W09 according to some embodiments.

FIG. 15 is a graph showing the oil flow estimates for the evaluation period for well W10 according to some embodiments.

FIG. 16 is a graph showing the oil flow estimates for the evaluation period for well W14 according to some embodiments.

FIG. 17 is a graph showing the oil flow estimates for the evaluation period for well W16 according to some embodiments.

FIG. 18 is an example chart of well test indicators latching “ON” for well W14 followed a couple days thereafter by wells W03, W10 and W16 according to some embodiments.

FIG. 19 is an example data table showing that four simultaneous indications where well test are needed according to some embodiments.

FIG. 20 shows an example autonomous remodeling process consistent with aspects of the present disclosure.

FIG. 21 is a graph showing example metrics for a well used to determine when a new well model should be performed according to some embodiments.

FIG. 22 is an example of configuration options used during the remodeling process according to some embodiments.

FIG. 23 is another example of configuration options used during the remodeling process according to some embodiments.

FIG. 24 is still another example of configuration options used during the remodeling process according to some embodiments.

FIG. 25 is another example of configuration options used during the remodeling process according to some embodiments.

FIG. 26 is a graph showing oil flow estimates for a well with data from a catch-up request process according to some embodiments.

FIG. 27 is a table showing example settings for a catch-up request process according to some embodiments.

FIG. 28 is a graph showing oil flow estimate for well W03 with data from a catch-up request process according to some embodiments.

FIG. 29 is a graph showing oil flow estimates for well W01 with data from a catch-up request process according to some embodiments.

FIG. 30 is an example graph showing “bi-modal” distribution according to some embodiments.

FIG. 31 is a graph showing a plot of all the models' platform meters bias terms during the evaluation period according to some embodiments.

FIG. 32 is a graph of the metrics during the later stage of the evaluation period when the platform was in a large turn-down according to some embodiments.

FIG. 33 is a graph showing the oil metric for well W01 in closer detail according to some embodiments.

FIG. 34 is a graph showing well W01 most sensitive input for oil according to some embodiments.

FIG. 35 is a graph showing oil flow estimates for well W10 with the confidence bands along with the production management advisory system estimates according to some embodiments.

### DETAILED DESCRIPTION

The present disclosure will be described in connection with its embodiments a method and system for modeling, monitoring, and evaluating water, oil, and gas flow rates for an asset comprising a collection of wells using a data-driven virtual flow meter (DD-VFM) system. However, it is contemplated that this disclosure can also provide important benefits in other applications, including the modeling, monitoring, and evaluating of other fluid flows in other applications such as water and sewer systems, natural gas distribution systems on the customer side, and factory piping systems, to name a few. Accordingly, it is to be understood that the following description is provided by way of example only, and is not intended to limit the true scope of this disclosure as claimed.

Referring first to FIG. 1, an example of an oil and gas production field, including surface facilities, in connection with which an embodiment of the disclosure can be utilized, is illustrated in a simplified block form. In this example, the production field includes multiple wells 4, deployed at various locations within the field, from which oil and gas products are to be produced in the conventional manner. While a number of wells 4 are illustrated in FIG. 1, it is contemplated that modern production fields in connection with which the present disclosure can be utilized will include many more wells than those wells 4 depicted in FIG. 1. In this example, each well 4 can be connected to an associated one of multiple drill sites 2 in its locale by way of a pipeline 5. By way of example, eight drill sites 2₀ through 2₇ are illustrated in FIG. 1; it is, of course, understood by those in the art that more or less than eight drill sites 2 can be deployed within a production field. Each drill site 2 can support wells 4; for example drill site 2₃ is illustrated in FIG. 1 as supporting forty-two wells 4₀ through 4₄₁. Each drill site 2 gathers the output from its associated wells 4, and forwards the gathered output to central processing facility 6 via one of pipelines 5. Eventually, central processing facility 6 can be coupled into an output pipeline 5, which in turn can be coupled into a larger-scale pipeline facility along with other central processing facilities 6.

In the example of oil production from the North Slope of Alaska, the pipeline system partially shown in FIG. 1 may connect into the Trans-Alaska Pipeline System, along with many other wells 4, drilling sites 2, pipelines 5, and processing facilities 6. Thousands of individual pipelines can be interconnected in the overall production and processing system connecting into the Trans-Alaska Pipeline System. As such, the pipeline system illustrated in FIG. 1 can represent only a portion of an overall production pipeline system.

While not suggested by the schematic diagram of FIG. 1, in actuality, pipelines 5 vary widely from one another in construction and geometry, in parameters including diameter, nominal wall thickness, overall length, numbers and angles of elbows and curvature, location (underground, above-ground, or extent of either placement), to name a few. In addition, parameters regarding the fluid carried by the various pipelines 5 also can vary widely in composition, pressure, flow rate, and the like.

FIG. 2 illustrates the configuration of modeling system 10 according to an example of an embodiment of the disclosure, as realized by way of a computer system. Modeling system 10 performs the operations described in this specification to determine a flow rate for each of oil, gas, and water in the asset system. Of course, the particular architecture and construction of a computer system useful in connection with this disclosure can vary widely. For example, modeling system 10 can be realized by a computer based on a single physical computer, or alternatively by a computer system implemented in a distributed manner over multiple physical computers. Accordingly, the architecture illustrated in FIG. 2 is provided merely by way of example.

As shown in FIG. 2, modeling system 10 can include central processing unit 15, coupled to system bus BUS. Input/output interface 11 can also be coupled to system BUS, which refers to those interface resources by way of which peripheral functions P (e.g., keyboard, mouse, display, etc.) interface with the other constituents of prediction system 10. Central processing unit 15 refers to the data processing capability of prediction system 10, and as such can be implemented by one or more CPU cores, co-processing circuitry, and the like. The particular construction and capability of central processing unit 15 can be selected according to the application needs of modeling system 10; such needs including, at a minimum, the carrying out of the functions described in this specification, and also including such other functions as may be desired to be executed by a computer system. In the architecture of modeling system 10 according to this example, data memory 12 and program memory 14 can be coupled to system bus BUS, and can provide memory resources of the desired type useful for their particular functions. Data memory 12 can store input data and the results of processing executed by central processing unit 15, while program memory 14 can store the computer instructions to be executed by central processing unit 15 in carrying out those functions. Of course, this memory arrangement is only an example, it being understood that data memory 12 and program memory 14 can be combined into a single memory resource, or distributed in whole or in part outside of the particular computer system shown in FIG. 1 as implementing modeling system 10. Typically, data memory 12 can be realized, at least in part, by high-speed random-access memory in close temporal proximity to central processing unit 15. Program memory 14 can be realized by mass storage or random access memory resources in the conventional manner, or alternatively can be accessible over network interface 16 (i.e., if central processing unit 15 is executing a web-based or other remote application).

Network interface 16 can be a conventional interface or adapter by way of which modeling system 10 accesses network resources on a network. As shown in FIG. 2, the network resources to which modeling system 10 has access via network interface 16 can include those resources on a local area network, as well as those accessible through a wide-area network such as an intranet, a virtual private network, or over the Internet. In this embodiment of the disclosure, sources of data processed by modeling system 10 are available over such networks, via network interface 16. Library 20 can store historical and/or current data or measurements for selected wells in the asset system; library 20 can reside on a local area network, or alternatively can be accessible via the Internet or some other wider area network. It is contemplated that library 20 can also be accessible to other computers associated with the operator of the particular pipeline system. In addition, as shown in FIG. 2, measurement inputs 18 for other wells in the asset system can be stored in a memory resource accessible to modeling system 10, either locally or via network interface 16.

Of course, the particular memory resource or location in which the measurements 18 can be stored, or in which library 20 can reside, can be implemented in various locations accessible to modeling system 10. For example, these data can be stored in local memory resources within modeling system 10, or in network-accessible memory resources as shown in FIG. 2. In addition, these data sources can be distributed among multiple locations, as known in the art. Further in the alternative, the measurements corresponding to measurements 18 and to library 20 can be input into modeling system 10, for example by way of an embedded data file in a message or other communications stream. It is contemplated that those skilled in the art will be able to implement the storage and retrieval of measurements 18 and library 20 in a suitable manner for each particular application.

According to this embodiment of the disclosure, as mentioned above, program memory 14 can store computer instructions executable by central processing unit 15 to carry out the functions described in this specification, by way of which measurements 18 for a given well are analyzed to determine and/or predict a particular fluid rate (oil, gas, and/or water) for a well associated with the asset. These computer instructions can be in the form of one or more executable programs, or in the form of source code or higher-level code from which one or more executable programs are derived, assembled, interpreted or compiled. Any one of a number of computer languages or protocols can be used, depending on the manner in which the desired operations are to be carried out. For example, these computer instructions can be written in a conventional high level language, either as a conventional linear computer program or arranged for execution in an object-oriented manner. These instructions can also be embedded within a higher-level application. It is contemplated that those skilled in the art having reference to this description will be readily able to realize, without undue experimentation, this embodiment of the disclosure in a suitable manner for the desired installations. Alternatively, these computer-executable software instructions can, according to embodiments of the disclosure, be resident elsewhere on the local area network or wide area network, accessible to modeling system 10 via its network interface 16 (for example in the form of a web-based application), or these software instructions can be communicated to modeling system 10 by way of encoded information on an electromagnetic carrier signal via some other interface or input/output device.

The data-driven modeling can be based on production conditions, historical results, and the well characteristics for the well that is being evaluated. The modeling can be made on a minute, hourly, or daily basis, if that is desirable, or summaries of fluid flow rates to date can be obtained periodically. The data-driven model can use an ensemble of models including, but not limited to neural networks, linear, non-linear, or logistic regression models.

FIG. 3 illustrates an exemplary method for autonomously and independently modeling a water flow rate, an oil flow rate, and a gas flow rate of a well associated with an asset comprising one or more wells using an ensemble of data-driven computer models in accordance with implementations of the present disclosure. The method can begin at 305. At 310, one or more parameters as measured by one or more sensors at one or more of a well bore, a well head, and one or more flow lines to a separator associated with the well during a well test can be automatically obtained and be input to a computing system. For example, the one or more parameters comprise one or more of: a well head pressure measured at a discharge portion of a well before a choke, a well head temperature measured at a discharge portion of a well before a choke, a casing pressure that is a measure of a pressure on a casing of a well caused by injected gas in a gas lift injected well, a flow line pressure that is a measure of pressure of a production measured after a choke, and an amount of choke.

At 315, the ensemble of data-driven computer models is created to independently model the water flow rate, the oil flow rate, and the gas flow rate based on the one or more parameters. For example, the data-driven computer models can include, but are not limited to, a neural network model, non-linear regression model, fuzzy rule-based model, genetic algorithms, evolutionary algorithms, chaos theory, non-linear dynamics, and support vector machines. Other linear and non-linear data-driven computer models can also be used as are known in the art.

At 320, each data-driven computer model of the ensemble of data-driven computer models can be evaluated based on historic, current, or both historic and current conditions. For example, each computer model can be evaluated based on the usefulness of that particular model for the same or similar input parameters. Computer models can be initially selected or discarded at a later time based on the results of the particular model. Since data-driven models are not constrained by any particular physical or statistical model, the computer models can be chosen that best work with the inputs that are available at the particular well or sets of wells being modeled.

At 325, a subset of data-driven computer models is selected from the ensemble of data-driven computer models that were evaluated to independently model the water flow rate, the oil flow rate, and the gas flow rate based on the one or more reservoir parameters. Again, each model can be evaluated individually or collectively against the other models to determine how closely or how divergent the results appear. For example, if one model relies heavy on data that is missing, corrupt, or producing results that are outside of what is expected for that sensor, then that model's result may not be as accurate as those produced by another model that does not rely on that data. Thus, the former model that is using the “bad” data can likely be discarded without significantly impacting the results.

At 330, each of the water flow rate, the oil flow rate, and the gas flow rate are modeled independently using the subset of data-driven computer models. Additionally, each parameter being modeled (gas, oil, or water) can also include a degree of confidence or confidence bands by which the estimated flows can be relied. This confidence metric can be provided in conventional units that are known in the art, including, but not limited to, barrels per day (bbl/d) or million standard cubic feet per day (mmscfd).

At 335, each of the water flow rate, the oil flow rate, and the gas flow rate that was independently modeled for the well can be reconciled with a total flow rate obtained at the asset. At 340, each of the water flow rate, the oil flow rate, and the gas flow rate can be outputted based on the modeling and the each of the water flow rate, the oil flow rate, and the gas flow rate can be outputted based on the reconciling. The outputting can occur at different time periods. For example, the reconciliation can occur hourly while the flow rate estimates from the models can be outputted in fifteen minutes. Other time increments can also be used.

The DD-VFM system is an autonomous system is fully functional after setup without human intervention. The DD-VFM system is able to learn from the flows of the data to make recommendations and direct its own functionality and actions without anyone at the asset or back office ever having to intervene. Also, the system can monitor during outages for the wells and assets and can start making new estimates as soon as startup occurs.

The DD-VFM system does not need a particular sensor, but utilizes sensor data with sufficient information content to extract and convert that information into useful production estimates. The DD-VFM system can use above ground (surface) sensor, sub-surface sensors, or combinations of both. For example, the sensors that can be used include, but are not limited to, sensors to measure lift gas injection rate, flow tubing pressure, casing Pressure, well head temperature, and choke Position (%). At a minimum, the DD-VFM system should have inputs from casing pressure and well head temperature, or casing pressure and flow tubing pressure to produce adequate results. If a choke is being manipulated to manage the well, then choke position is required. Any additional sensors beyond these are likely to generate even more accurate results. Because information in the sensors is “cross-correlated”, if casing pressure and well temperature are not available, other sensors may contain sufficient information to make up for their absence. The modeling technology used is self-optimizing with input variable selection that aids in eliminating inputs that are correlated with others and may induce more noise than additional information. In the end, due to sensor variance, quality, reliability, repeatability, location, and other factors, the only true way to determine if a well has the necessary information within the sensors available is to model the data and examine the results. The modeling engine is capable of searching through these different combinations of process variables (sensor data) and model types. Sensors that have redundant information can be removed from the modeling process since these can contribute more noise than information.

The DD-VFM system as disclosed herein outputs estimates in real-time for oil, gas and water for each well during and between well tests, providing production insights when not on test. The DD-VFM is an autonomous self-calibrating system and will be discussed in relation to field trials that were conducted on an actual platform from January through June, 2013 to illustrate the features of the present disclosure. The virtual meters were deployed for oil, gas and water production on wells W01, W03, W05, W06, W07, W09, W10, W12, W14, W16 and W20 on a development server, using historical and real-time data from multiple process intelligence (PI) data historians (also known as, operational historians, PI tags, or PI) from PI software from OSIsoft, LLC in San Leandro, Calif. Other suitable PI software can also be used as is known in the art. The data historians are operable to capture, process, analyze, and store any form of real-time data. In the DD-VFM system, the data historians perform numerous functions including issue standardized quality metrics with each estimate made, validate well tests encountered, indicate when well tests should be conducted based on wells operating outside the range of prior well tests, handle multiple wells simultaneously tested, “catching up” estimates and other data operations after data/network/server/system outages, and provide for fully autonomous operations. In the below examples, real time oil and gas allocations were also made hourly using a “magnitude and variance” back-allocation algorithm. Allocations of the official allocated gas was not possible because arriving at the allocated amount involves manual calculations by humans, so “gross gas” was allocated for demonstration purposes.

Generally, performance (accuracy) of the DD-VFM system can be measured in two ways. The first method is to compute and compare the sum of estimates versus the platform meters. The second method is to compare estimates to test separator metered production while wells are under test. In the disclosed examples, only six wells were tested once and only during the very beginning of the field trial due to platform mechanical issues that were encountered. Overall, well test accuracy overall was about 80%, with 81% on oil and 78% on gas. When looking at the sum of estimates versus the sum of meters at the platform level, using samples that covered a broad range of operational production levels, oil was 87% accurate, and if 15 minute averaging is used, 93% accurate. Gas was 76% accurate (n=58,600) and 72% accurate if 15 minute averaging is used.

As demonstrated in the results, the tested asset encountered challenges during the trial due to mechanical problems causing them to operate without lift gas and only a few well tests were conducted at the very beginning of the field trial and were operating at low capacity (a production turn-down of 70-90%). The lack of well tests for nearly the entire trial is notable because they are used as a part of the DD-VFM system production estimate performance management. Due to these challenges, the virtual flow meters were “stretched” to operate at production levels notably lower than historical. For autonomous self-calibration, the DD-VFM system principally relied on the “other half” of performance management back-allocated bias from adapting to the sum of estimates vs. the sum of sales meters. This also limits the estimates' performance metrics to these sums and comparison to other algorithms. On the very few well tests in the beginning of the field trial, oil was 81% accurate, gas 78% and water 71%. When comparing the “Sum of Estimates vs. Sum of Platform Meters” from March 1 to April 15, the evaluation period, oil averaged 87% accurate on the raw meter readings and 90% on 15 minute averaged estimates and meter readings, shown in FIG. 4, where 401 is the meter readings, 403 is the sum of estimated oil productions, and 405 is the production management advisory system sum of estimated productions, all on a 15 minute average.

As can be seen in FIG. 5, DD-VFM system estimated gas is 73% accurate comparing 15 minute averaged estimates and meter readings and though the production management advisory system readings traded places back and forth with the DD-VFM system estimates during low production, both reading high, production management advisory system also came in at 73% accurate. In FIG. 5, 501 is the meter readings, 503 is the sum of estimated oil productions, and 505 is the production management advisory system sum of estimated productions, all on a 15 minute average. The fact that production management advisory system and the DD-VFM system estimates were above the meters during low production might suggest that the meters were reading low during low production. However, FIG. 6 shows a comparison plot of DD-VFM Estimated water 601 and production management advisory system estimated water 603.

FIG. 7 shows a table with the result of the well tests during the evaluation period. The mean well test accuracies overall and by phase are oil: 81%, gas: 78%, water: 71%. These results were about a “Class C” (greater than or around 80% accuracy), which was expected because the system operated as a “Class C” system (no auto calibration on well tests) due to platform issues that were encountered during testing. Increased performance to a “Class B” (accuracies >90%) and approaching “Class A” (>95% accuracy) (approaching “Class A”) have since been achieved.

Well test occurrences can be provided by the asset within various data historians in the data historian post-facto (after the test was complete). Additionally or alternatively, well test occurrence can be deduced based on valve positions as the activity starts, continues and completes by monitoring well operating states and valve positions. Detecting tests using this method offers flexibility and additional information content to the well test data. The prior indications of well tests were as the well operated at steady state where after the well had “lined out” (most often essentially a single data point with many readings with induced sensor noise), by observing that a well was valved to the test separator. The indication of well tests can provide useful process dynamics that can be captured in the data as pressures and temperatures changes until a steady state condition is achieved.

In implementations, well operating state can be determined based on monitoring the choke position. For example, in one actual implementation, the choke was nearly always opened while operating and closed when shut in. During testing on the actual implementation, leaving the choke open during a well shut-in was a rare exception; however, initial analysis of the data for another implementation showed choke was left open more frequently while not producing (other valves being closed). That is, the well was valved to the test separator, choke open, but not producing. However, it could be observed that the well head temperature would be at a cool ambient and rapidly heated as the well was started, and that this was always true and was a physical attribute (following physics) and the “choke-open, not operating” situation could be avoided. Accordingly, a threshold on well temperature was used to indicate that a well was operating. This gives slightly different results than using choke position and led to some discrepancies between the DD-VFM system and production management advisory system regarding whether a well was operating.

In implementations, the DD-VFM system can also handle concurrent tests where tests can be simultaneously conducted by putting one well through the test separator and also at the same time configuring one well to exclusively flow through a production separator. The DD-VFM system can operate parallel processes that are configured to monitor, detect, process and adapt the DD-VFM system for testing using both separators. Hence, the DD-VFM system can handle multiple wells being conjoin tested in the same separator (using an allocation scheme) and also parallel testing on multiple separators.

In implementations, the DD-VFM system can also import data historians in bulk. Because there were more than 200 data historians in an example field trial and the data historians IDs were provided in a spreadsheet data table, the data historian import process permits “bulk” import using the table. This process automatically checks that the listed data historians exist, map each in, assign a “meaning” to each tag (using a column header) and assign a tag to an indicated context (platform or well), creating the context if need be, open the table, validate the tags, and import the tags.

In implementations, the DD-VFM system can allow for centralized well state and well test detection. In prior implementations, well test detection was implemented in various places, such as well test data archiving and model performance management. Similarly “well operating/not-operating” was distributed about in most processes, including each production estimator. These well state detection processes were implemented just once per well and archived in the local historian so that a history can be seen and the numeric flags of whether the well is operating and/or on test can be used easily in data handling templates throughout the system. This also makes it easy to change the algorithm for deducing well states yet makes it flexible on a per-well basis, if needed.

In implementations, the DD-VFM system can allow “catch-up” operations by being able to “back cast” estimates and other DD-VFM system operations should data historians, the network, the server hosting the DD-VFM system or the DD-VFM system itself go off-line for a period of time. Accordingly, the DD-VFM system infrastructure may include a dynamic time-based “dual logic” about data access. Normally, current values are retrieved from data sources and processed, but if no data is returned for a definable period of time, the “current value” logic switches to “give me data since a date/time” and when that data block finally arrives the whole block is processed and results are written to the data destination, such as data historian. The logic, having received data up to a point, most often current values again, reverts to the “current value” logic again.

In implementations, the DD-VFM system can improve model quality metrics by having streaming model quality estimates written for every production estimate. These metrics can be separable from the estimation process itself so that the algorithm could be changed. Previously, “Model Quality” was the degree of whether a model's inputs were within an n-dimensional “envelope”, the ranges that were used when constructing the models while on test. For example, the “envelope” can be a range of the inputs used to create the model and can be a “hypercube” or “Spheroidal” metric calculated as the resulting vector magnitude of the positions of inputs within their range. If the metric is within −1 to +1 then the model is generally “within envelope”. The amount beyond +/−1 is indicative of the degree the inputs are outside the “experience” of the model. While this is useful, the value ranged from zero (“good”) to any number (higher is bad), including values such as 2.343, which is hard to interpret, difficult to explain and have someone understand. Instead, in the DD-VFM system, the value range is bounded between 0 and 1 where 0 is “bad” (no quality, no confidence) to 1.0 (perfect) including a confidence band around the values.

In implementations, the DD-VFM system can allow for well test validation, which in combination with well test detection, can allow data handling that rejected grossly invalid data during well tests, such as data falling outside limits. These limits are settable in data handling templates and are configurable by well and phase. If insufficient rows remain after validation, the entire well test can be invalidated.

In implementations, the DD-VFM system can allow for well test recommendations. For example, an indicator can be written to a data historian for recommending whether or not a well test should be done as soon as practical. The DD-VFM system can use an “anomaly” detection system to determine when current operating conditions, for some number of readings, is significantly n-dimensionally outside prior well test values, suggesting the well is operating under conditions not seen in prior tests. This anomaly event series can be written to data historian as a time series indicating degree of abnormality. A drawback to this approach is that the indications appear only when the well goes “out of envelope”, and then the well returns “in envelope” again giving brief “pulse-like” indications. Alternatively, the “anomaly” detection system can include a [0, 1] indicator of when a weighted sum of the oil, gas and water estimate qualities fell below a configurable threshold (e.g., 0.85 decimal fraction). Additionally, n-dimensional metrics can be used to indicate that the wells are operating outside prior well test values because the models are built using filtered well test data. This indication can be made to “latch on” until such time a test was conducted for the well. FIG. 8 shows a trend chart of the indicators showing the indications and FIG. 9 shows a data grid showing W03, W10, W14 and W16 are showing well test suggestions.

In implementations, the DD-VFM system can allow for persistence of operating states during DD-VFM system shut-down by logging certain states and time-stamps. For example, each time new data is received the date/time of the most recent data record is “remembered” so that even if the DD-VFM system is turned off, it recalls that information on re-start.

In implementations, the DD-VFM system can allow measuring sparse, individual well production without well tests. When well tests are sparse, individual well production information can be gleaned from when wells are brought on individually or in small sets such as pairs. In an effort to gain information regarding measured individual well productions during the field trial that had no well tests at all after the initial period, a platform startup was manually analyzed. It is recognized that in some cases wells have abnormal behavior on starts, such as a spike and decay production, others merely slowly climb, so values determined have a degree of uncertainty to them. From this analysis, the individual productions of four wells were approximately quantified and production estimate models were manually adjusted. This process can be made “autonomous” and can contribute to a third view of production (well test, platform meter adaptation and now differential well starts and shut-ins).

In implementations, the DD-VFM system can convert good-questionable-bad categorization of DD-VFM values to numerical pseudo-standard errors. Initially, “model quality” was the sensitivity weighted compressed degree that the inputs were within the multi-dimensional combined distance envelope of input ranges used to build the models, essentially filtered well test conditions. This gave a scale of 0-1 where 1 indicates estimates are good. It was desired to have a confidence interval based in units of measure, such as bbl/d (barrels per day) or mmscfd (million standard cubic feet per day). The estimate qualities can be converted into a 95% confidence interval in units of measure. FIG. 10 shows an example confidence interval with a 30 period smoothing applied for well W16's oil estimates. The line, indicated by arrow 1001, is the upper 95% confidence, the line, indicated by arrow 1005, is the lower 95% confidence and the line, indicated by arrow 1003, is the estimated production.

Both measures are good and the units based confidence intervals can be calculated from the 0-1 ranging “estimate quality” by multiplying the Root Mean Square Error encountered when modeling by 1-Quality. That is, the further out of envelope, the poorer the quality, the wider the confidence band around the estimates. The following are plots by operating well, for oil, from May 1^{st} to Jun. 1, 2013 as evidence of this accomplishment and show confidence bands around the estimate for periods where the well was continuously operating (date ranges may vary to capture just operating periods). Confidence bands have been smoothed with a 30 period moving average.

FIGS. 11-17 show plots for W01, W03, W06, W09, W10, W14, W16, respectively. Wells W05, W07, W12, W15, and W20 were not operating during the test period. The FIGS. 11-17 show plots of the units of measure based confidence interval, where “tighter” bands around the estimates are smaller uncertainty, in barrels where the upper 95% confidence is indicated by 1101, 1201, 1301, 1401, 1501, 1601, 1701, respectively, the lower 95% confidence is indicated by 1105, 1205, 1305, 1405, 1505, 1605, 1705, respectively, and the estimated production is indicated by 1103, 1203, 1303, 1403, 1503, 1603, 1703, respectively.

In implementations, the DD-VFM system can create an internal event and initiate a well test validation process when a well test is detected in order to ensure that well tests are good well tests. For example, well test can be detected based on when the test starts and then when the test is completed. Configurable key process conditions and production data can be extracted from data historians and can be processed through configurable limiting filters allowing reasonably ranging values and discarding obviously erroneous data. If a specified number of rows are not remaining after filtering, the well test data is rejected and not archived, nor used for any validation or adaptation process.

In implementations, the DD-VFM system can be configured such that the data historian can enable recommendations on whether or not a well test should be done as soon as practical with comparison to a particular testing sequence. Initially in the field trial, “Test needed” indications for each well were scaled values that were non-zero only during times that the process (well conditions) were out of envelope with respect to prior well test conditions. The magnitudes of the scaled values were based on the degree of out of envelope. However, this most often resulted in brief pulses as the well briefly went out of envelope, and then quickly went back into envelope. Alternatively or additionally, the DD-VFM system can be configured to allow the well test indicators to latch on at 1.0 and hold until a well test was done.

FIG. 18 shows an example chart of well test indicators latching “ON” for W14 followed a couple days thereafter by W03, W10 and W16. However, in FIG. 18, W03, W10 and W16 appear as one line because they started their indication nearly simultaneously. The DD-VFM can be operable to obtain the “Quality” of oil, gas and water estimates from the data historian and apply a weighted sum of those three (weightings are configurable) against a criterion (such as the quality result is less than 0.85) and if so, turn on a well test needed flag which is written to the data historians. The DD-VFM system can then be operable to look for well tests and if one is seen for that well, the flag is turned off. The DD-VFM system is configured to provide adjustable weightings, the criterion, and the method used to compute the decision. In the examples shown in FIG. 18, the weighting on oil, gas and water was equal (0.33, 0.33, 0.33) and a criterion used was that their weighted sum must remain above 0.85 in order to not trip an indication.

FIG. 19 shows a data table with four simultaneous indications of well test needed are ON just before the platform went down for maintenance. The indicators did not go off because no well tests were conducted.

Alternatively or additionally, other means of calculating when a well test is needed are possible and can be considered on an asset-by-asset basis, such as using the degree the system must adapt to the platform meters, because if heavy adaptation is required, a well test can recalibrate the estimates. Alternatively, a combination of adaptation degree with degree “in envelope” could be considered.

In implementations, the DD-VFM system can be operable to detect a failed sensor and determine that the autonomous operation can continue with a new model. Any system that uses data as an input, regardless if they are theoretical or data-driven models, must be watchful of the data received (or not received). “Bad Data” situations can occur very frequently. In data driven models, one must make a proper decision whether to remodel to exclude an input, particularly an important input, or merely to keep a good model and just not write a result during data analysis. Additionally, one should consider whether there is a direct relation between external data and an “input” to a model. It is often the case with data pre-processing that the role of a process variable can be expanded to many inputs in a model, or that a predicted variable can also be an input, such as using lagged prior predicted values as inputs. In this case, at this time, there is a direct association of a data historian and an input. Also, external data is used many places within the solution, in many ways, at the same time, expanding bad data's effect well beyond models.

The below discussion first focuses on data handling, the multi-use and multivariate impact of data and then the autonomous remodeling process implemented as part of the field trial based on seriously missing or badly formed data for an extended period, which could be done because there is a direct relation between external data and an “input” to a model.

In implementations, an autonomous remodeling process can be invoked based on two drivers including model performance on test, extended invalidity, and loss of a sensor. For a well and phase the data used by the model is monitored and through a data handling scheme determines if the data are valid or invalid using various rules, which can include checking ranges and looking for null values and text within the numeric data. If the data is OK, a variable's data is marked “0” and if invalid it is marked “1”. Next, the system looks at the data timestamps of the invalid data and computes how long it has been invalid. “Hours” was used in this case. The time of last good values can be stored in case the system goes down. Next, duration of invalidity criteria by variable are evaluated to determine whether to disable (or enable, or other states) an input to a model. If it does make a change, it sends this information downstream where the modeling configuration file input state(s) is changed physically on disk. Upon successful completion of that action, an “Execute” command is sent to the remodeling process, the first step of which is extracting blocks of well test data and remodeling executes with the noted input(s) disabled.

“Bad Data” can manifest itself in many ways, including no data being received upon request for a single value or all requested “tags” and text being received when a number is expected. Also, these can include literally “Bad Data”, “I/O Timeout”, etc. found within numeric data from data historian (or other sources). Further, numbers are received, but they are not within an expected range. For example, a range between 0-100 is expected, but a negative 400 is received. However, receiving and handling “Bad Data” is a normal operation within the DD-VFM system. Missing and invalid data can happen a lot, every day, anytime, thus the duration for which data is “bad” or missing becomes the next aspect for consideration. If the sensor is suspected to not be available for an extended period and the system can operate well enough without it, then action can be be taken, either by a human or autonomous remodeling, if possible. “Mission Criticality” of each operation determines what decisions need to be made and actions taken on a case by case basis. Virtual sensors are typically less critical than controlling a process using model predictive control. In some applications, it may be preferable to merely notice that no estimates come for a time, autonomously raise a “ticket” and an investigation is conducted by a human and a correction made. In mission critical solutions, then clear definitions are established and most often a human analyst assesses the situation, what can be done, if anything, rebuilds and validates models, puts them on-line.

Within the DD-VFM system, no data at all means no estimate (or other operation). The DD-VFM can track the last good receipt of data and store in memory by each data access task instructed to do so. This is used for “Catch-Up” operations, such as when servers go down, or data historian has a problem or the network, etc. No data at all across many variables generally indicates a “systemic” problem, not a bad variable, and thus remodeling is not appropriate. No data for individual elements (variables) can be handled on a case by case basis at multiple levels in each component of the DD-VFM system, depending on the criticality of the missing element to the task at hand. Each data consuming task has an available “No operation on null data” setting that can be turned on and off in the DD-VFM system. This setting means that if there is no value on any variable, no operation takes place.

Generally, text data when numeric is expected can be filtered within tasks' data handling to drop data rows containing text, or converted to a value including optionally NULL, thus on line that means no estimate if “No action on Null input” is true. Out of range (“invalid”) values can be handled on a case-by-case basis, such as limiting it to a range enforcing a minimum or maximum, or nullify it by “clipping”, or carry forward a prior value, or invalidate an entire row of data, or other scheme. Moreover, the DD-VFM system can be operable to allow for a variable time frame, for example one week, in which “bad” data can be used or tolerated.

The DD-VFM system is operable to use multi-use and multivariate processes that allow more than merely creating production estimates, but also determining the operational state of wells, including whether a well is on test and other operations. Some of these variables are used both for state detection and models, such as choke and well head temperature. So if there are significant, lengthy data issues in those two cases then numerous operations cease, not just estimates.

While a set of variables are used to feed a production estimator, they are not necessarily directly fed into the models themselves. In between the data coming in and the models resides a data handling template where not only data quality is handled, but also pre-calculations that go into the models. If those calculations increase or decrease the number of inputs, then the direct 1:1 mapping may no longer apply. An example is that the modeler may decide to compute new data columns, or delete data columns, from incoming data to use as inputs to the models. There are about 100 functions that can be used in any combination and thus vast possibilities exist. However, in the field trial, direct cleansing and passing of data to the models was used, thus there was a 1:1 relation between data and “inputs” and thus it was possible to turn off inputs based on extended bad data. The reverse is true as well. Often the inputs to a model are set “Input Optional” and the modeling engine decides to turn on and off inputs based on their utility. Thus it is possible that a “bad variable” is not actually used in a model and remodeling is unnecessary.

FIG. 20 shows an example autonomous remodeling process consistent with aspects of the present disclosure. The autonomous remodeling process can be invoked based on two drivers, including model performance on test, extended invalidity, and loss of a sensor. In this example, the extended invalidity or loss of sensor is discussed. For a well and phase, the data used to construct the model is monitored by a data handling task (“W01 Get Monitored PI Tags”) at 2005. This process queries data historians on a timer getting the tag values. At 2010, “W01 Tag Value Validity Check” uses a data handling scheme to determine if they are valid or invalid using various rules, including, but not limited to, checking ranges, looking for null values, and looking for text within the numeric quantity. If the data is OK, a variable's data is marked “0” and if abnormal marked “1”.

At 2015, “W01 Time Since Last Good Value” looks at the data timestamps and whether the tag is marked good or bad and computes how long it has been invalid. “Hours” was used in this case. The time of last good values can be stored in memory in case the system goes down. At 2020, “W01 Invalid to Off Converter” contains criteria by variable whether to disable (or enable, or other states) an input to a model. If it does make a change, it sends this information downstream. At 2025, “W01 ModifyMCSGroups” knows where the modeling configuration file is and changes input states in memory. Upon successful completion, it sends an “Execute” command to the remodeling process, the first step of which is extracting blocks of well test data (“W01 Oil Get WT Records”) at 2030 and 2035. The remodeling executes with the noted input(s) disabled at 2040. The criteria for “bad input” were set to 7 days (168 hours) across all variables. This process did not fire during the field trial because the criteria were not met, so the criterion was manipulated manually invoking the process to test its proper operation.

The process shown on the right side of FIG. 20 begins at 2045 where the remodeling process obtains blocks of well test data (“W01 Oil Performance GetDataDLT”). At 2050, the remodeling process receives a request to evaluate new well data (“W01 Oil Request NewDat Eval Expression”). At 2055, the remodeling process obtains the last well data (“W01 Oil Las WT Event GetDataDLT”), and at 2060, the remodeling process obtains the last modeled results (“W01 Oil Last Modeled Get File MetaData”). At 2065, the remodeling process determines if new data is available since the last model was made (“W01 Oil Determines if New Data Since Last Model Dat”), and if new data is available, then the remodeling process sends the new data to be modeled (“W01 Sends ReModel Expression”). The process then follows steps 2030, 2035, and 2040, as discussed above.

First, the “Time Since Last Good” task logged its metrics from March 1 through April 15, 256,000 rows and observed as shown in FIG. 21. As can be seen in FIG. 21, the worst period of time reached about 3.5 hours, due to Tdwnstrm. The criteria in the “W01 Invalid to Off Converter” task were set to 3 hours and the remodeling process initiated. Before execution, the “Groups” section of the modeling configuration file which holds how inputs are to be handled looked like the example shown in FIG. 22 where the Tdwnstrm variable is Group_{—}6 and is set to “1” (Optional input). Post-execution of this process, Group_{—}6 is set to “32” (Ignored input) as shown in the example FIG. 23. Just prior to making this change, the ModifyMCSGroups backs-up the modeling configuration file to avoid loss. The old version of the file is renamed and is shown circled in FIG. 24. Upon opening the new model, it can be seen that the user interface is now operating with CLR-TI110732 as “Ignored” as shown in the example FIG. 25. Thus, the ability to, in real-time, turn off inputs and remodel based on input quality can be performed.

In implementations, the DD-VFM system can be operable to allow the production estimators to recover from outages. In prior implementations, if there was an outage such as a data historian down, network nonfunctional, the server hosting DD-VFM system rebooted or the DD-VFM system itself taken off line, when the outage cleared, the DD-VFM system would merely pick up at current time and march onward. The data that was not received was never processed. A “Catch Up” data handling feature is implemented that allows processes when “current values” have not been received for N-requests (a period of time, such as an hour), these real-time data requests switch into a “give me a block of data” starting from the last data received up to the current moment. When the DD-VFM system or the network, etc. returns, then a block of data is obtained and processed and written to the data historian to provide the missing production estimates, well test suggestions, model qualities, etc. The catch-up requests a block of data from the data historian, which is “as recorded” not just on 15 minute intervals, so this results in a “busy” estimate written back to the data historian and while this busy-ness could have been removed it was left in so it could be seen in FIG. 26, with the catch-up circled and indicated by 2605. The data access tasks can be set to get current values on a timer but also to get values since the last were received, as shown in the settings depicted in FIG. 27. So if no data comes for a configurable N timer firings (N=4 in this case, 1 hour) then it will query the data source (data historian in this case) back to the last date/time data had been received, up to a limit. As evidence of this in operation, the FIG. 28 shows a “catch-up”; the “squiggly” estimates on W03 oil. No data was received for a period and then the DD-VFM system started requesting data back to the last receipt. This query gets all values recorded in the data historian during the requested period, not just on a 15 minute interval, thus the “squiggles” appear. These squiggles can be eliminated by implementing a 15 minute summarization but were left it as-is so the catch-ups can be seen. FIG. 29 shows another example on W10 oil.

In implementations, the DD-VFM system can be operable to identify any situation when its results are bad. There are two fundamental ways used to estimate the quality of estimates. One is to look at the estimate itself, the other is to look at the data driving the estimate. A quality metric can be used such as a 0-1 number where 1 is good. When this metric falls below a threshold, the estimates come into question. Alternatively or additionally, a confidence interval can be used in units of measure. When this becomes excessive the results again come into question. Regarding the output, the degree of adaptation, both on well tests and allocated bias from the sales meters gives an indication of the quality of results.

It is useful to have an estimate of the quality of the production estimates so that the consumer of the estimates has an idea how good they are at the moment and also in regards to managing quality within the DD-VFM system. The estimate quality “gold standard” is to compare estimates to metered production, but even that has caveats because under low flow conditions or during mechanical issues the meters may not be accurate. The various ways of estimating and measuring quality at a well level are discussed using W01 oil as an example.

As mentioned above, there are two fundamental ways to estimate the quality of estimates. The first is the evaluation of estimates. During modeling itself, an indication of the variance of estimates vs. metered production is first indication. For example, “Root Mean Squared Error” (RMSE) of the models' estimates vs. actual is a given statistic. W01 oil during modeling showed that the RMSE was 163.89 bbls/day. On-line estimates later can be, but are not likely to be, better than this. Any estimate given should be considered +/−164 bbl/day at a minimum. This statistic is later used to convert on-line estimate qualities into units of measure. Well tests are another means to compare well level production estimates to production after a model is constructed. They can be considered the “gold standard” and such results can be used for initially constructing models, model adaptation and if necessary, reconstructing models autonomously. It is acknowledged that metered production is always within some error of measure, and that error can be quite large in some circumstances, such as high or low flow or mechanical issues. Instrument assessment studies can also indicate the degree of error at differing conditions. It can be assumed that estimates are less accurate than the meters, but it is possible the estimates are more accurate.

Another perspective is to look at the current estimated values from the models vs. the production rates while on test, the range and distribution of production used to create the model. If the current on-line estimates are statistically significantly out of that range, uncertainty increases. FIG. 30 shows an example graphic where the top “bi-modal” distribution is the estimates while operating on-line. In the lower half, the “distribution” while on test is shown. As can be seen, the right-most distribution in the top chart is within the range of the well test history and can be more confident of these estimates. The left distribution in the top chart is outside of the well test history, thus confidence should be lowered.

It has been observed that production distributions are often multi-modal, as seen on the top of FIG. 30, even when on test. As such, a simple “Gaussian standard deviation” which relies on a single distribution may not be appropriate, but a multi-modal form of assessment may be useful. The assessment could include such analysis as “Am I near or within one of the peaks I saw before?” or “Am I within a general range comprising 2-sigma below a lowest production peak and 2-sigma above the upper most peak?” as is known in the art.

Another metric available to use from a production (model output) standpoint is the adaptation bias from the production meters. Here the sum of all wells estimates are compared to the sum of production meters and an average error is computed over a moving window. This error is allocated back to each well's production estimate proportional to the magnitude of the estimate. Thus bigger producers get bigger adjustments. This too gives an indication, to a degree, of an individual well's error, if one is comfortable in making some assumptions. Large bias reduces one's confidence in the models and vice versa. FIG. 31 shows a plot of all the models' platform meters bias terms during the evaluation period. There are times when the adaptation is heavy (lower confidence) and near zero (higher confidence). This information is tracked, archived and used within the DD-VFM system to keep estimates “on track”.

In a similar manner just discussed, but instead on inputs, the DD-VFM system can be operable to monitor current values of input variables and computes a sensitivity weighted metric from 0-1, where 1 is where all input values to the model are perfectly centered within their ranges of the well test data used to construct the model. This metric can be written to the data historian for inspection by the user of the estimates. Later, the metric can be converted to a unit based confidence interval such as +/−X bbls/day. The sensitivity weighting enables the metric to react when important variables go out of range and not react when unused or weakly used variables go out of range. FIG. 32 shows a plot of those metrics during the later stage of the pilot when the platform was in a large turn-down. FIG. 33 shows W01 oil's metric for closer detail. The depicted range is based and may be improved using a distribution based scheme discussed earlier on production, because input variables like production may not be Gaussian single-mode distribution, but multi-modal. FIG. 34 shows W01 oil's most sensitive input; operating conditions on top, data used to build the model on bottom. As can be seen, they are similar and the operating conditions are just within the lower distribution. The DD-VFM system can combine several of these methods to better identify when its results are bad, and thus develop a yet clearer picture of the confidence in the DD-VFM system estimates.

The DD-VFM system can be operable to handle co-mingled wells (multiple wells simultaneously through the same separator).

As the DD-VFM system and the production management advisory system both write their results to the data historian, it is possible for the two systems to be compared, both off-line and in real-time. Since the DD-VFM system is automatically and autonomously recalibrated against the meters, both during each individual well test and adapting to the sum of estimates vs. the sum of meters, production management advisory system models can be monitored and compared to DD-VFM estimates, including comparing estimates in and outside the streaming confidence bands around the DD-VFM estimates. Should the production management advisory system estimates go outside of these bands for an extended period an alert can be raised indicating the situation and the production management advisory system recalibration can be considered. FIG. 35 shows a chart showing W10 DD-VFM oil estimates with the confidence bands along with the production management advisory system estimates. Circles 3505 are shown where there is a deviation.

During the DD-VFM system field trial, it was observed that the production estimates at times had movements counter intuitive to the operating conditions of the individual wells. Excluding counter intuitive movements due to manual changes and experiments conducted after the autonomous operations evaluation period, counter-intuitive behavior was also seen during the autonomous operations evaluation period. This was found to be principally due to adaptation of the DD-VFM system's estimates to the sales meters particularly when the platform was operating at 75-90% “turn-down” with no lift gas. Since there were no well tests during these conditions the DD-VFM system relied principally on the sales meters for self-calibration.

While “Class A” models are fully intuitive by design (constructed with multi-rate well test data to purposely capture the well dynamics in detail), this system uses “Class B” models (constructed with steady state well test data, as available) and due to platform issues these models were operated under “Class C” conditions (no well test feedback except for 1 test in March). Thus some counter-intuitive behavior is to be expected at times particularly during periods where heavier adaptation to the sales meters is occurring. It was seen that the “Class B” production estimation models' raw outputs were reasonably intuitive during operation and the principal intuitiveness issue was found to be how they were adapted to the sales meters.

A sales meter adaptation algorithm is disclosed that eliminates or reduces counter-intuitive adaptations to the sales meters. This algorithm enables not only controlling the degree of adaptation (“Don't over adapt to the meters”), but preserves the intuitiveness of the underlying models using a “congruence” algorithm (“Don't go against the models' response to physical changes”). The algorithm is configured by asset and phase and is represented in the following parameter settings.

The first parameter setting is congruence. Intuitiveness is principally a 1^{st} derivative entity. “Choke was opened thus production should go up” is a “rate of change” statement with implicit timing (“it should go up . . . at this time”). Accordingly, there is a “directionally correct” aspect of the rate of change of the process conditions and the DD-VFM system estimates at the moment the sales meter adaptation adjustment is made. The view of “congruence” is if the raw model estimate is rising because the choke was opened more, but the sales meters say the production should go down, then the adaptation algorithm should not take a counter-intuitive action. Since any “domain knowledge” (operating conditions) is avoided in the sales meter adaptation algorithm, with the domain knowledge implicit in the model outputs, the only adjustment is of the unadapted estimates when the sales meters adjustment is “congruent” with the underlying model's estimate movement. A factor called “congruence” was then created in the bias back-allocator task in the DD-VFM system used for sales meter adaptation. It is a True/False flag that if true, if the meters are saying to go up in production and the model's production is going down (and vice versa), the adaptive adjustment is “tabled” for now, allowing the estimate to move intuitively. A newly calculated adaptation adjustment is reconsidered on the next bias computation. Conversely, if the sales meters based adjustment is congruent with movement of the unadapted estimate, take the adjustment, which then will be likely intuitive, just slightly more pronounced. This is an asset level feature since it uses the platform sales meters and easily turned on and off.

Another parameter is magnitude control. Additional settings were added that control the degree of adaptation: “Bias Potency” which applies x % of the calculated bias adjustment; “Max Assignable Fraction Error” that is conceptually in fractional units of measure (no more than X bbl/day or mmscfd at a time); and “Max Assignable Fraction Error Rate of Change” which is a derivative term that limits the rate of change to x % of current production. These control the size and the rate of change of the change.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the present disclosure has been described according to its preferred embodiments, it is of course contemplated that modifications of, and alternatives to these embodiments, such modifications and alternatives obtaining the advantages and benefits of this disclosure, will be apparent to those of ordinary skill in the art having reference to this specification and its drawings. It is contemplated that such modifications and alternatives are within the scope of this disclosure as subsequently claimed herein.

What is claimed is:

1. A computer-implemented method for autonomously and independently modeling a water flow rate, an oil flow rate, and a gas flow rate of a well associated with an asset comprising one or more wells using an ensemble of data-driven computer models, the computer-implemented method comprising:
automatically obtaining one or more parameters of the well as measured by one or more sensors at one or more of a well bore, a well head, and one or more flow lines to a separator associated with the well during a well test;
using the ensemble of data-driven computer models to independently model the water flow rate, the oil flow rate, and the gas flow rate based on the one or more parameters;
evaluating each data-driven computer model of the ensemble of data-driven computer models based on historic, current, or both historic and current conditions;
selecting a subset of data-driven computer models from the ensemble of data-driven computer models that were evaluated to independently model the water flow rate, the oil flow rate, and the gas flow rate based on the one or more parameters;
modeling each of the water flow rate, the oil flow rate, and the gas flow rate independently using the subset of data-driven computer models; and
automatically reconciling each of the water flow rate, the oil flow rate, and the gas flow rate that was independently modeled for the well with a total flow rate obtained at the asset;
outputting each of the water flow rate, the oil flow rate, and the gas flow rate based on the modeling and outputting the each of the water flow rate, the oil flow rate, and the gas flow rate based on the reconciling.

2. The computer-implemented method of claim 1, wherein the one or more parameters comprise one or more of: a well head pressure that is measured at a discharge portion of a well before a choke, a well head temperature that is measured at a discharge portion of a well before a choke, a casing pressure that is a measure of a pressure on a casing of a well caused by injected gas in a gas lift injected well, a flow line pressure is a measure of pressure of a production measured after a choke, and an amount of choke.

3. The computer-implemented method of claim 1, wherein the ensemble of data-driven computer models comprise one or more of: a neural network models, non-linear regression models, fuzzy rule-based models, genetic algorithms, evolutionary algorithms, chaos theory, non-linear dynamics, and support vector machines.

4. The computer-implemented method of claim 1, further comprising applying one or more statistical algorithms to prepare the one or more parameters for modeling.

5. The computer-implemented method of claim 1, further comprising determining that one or more values in the parameters is outside a predetermined threshold and removing the one or more values that were determined to be outside the predetermined threshold.

6. The computer-implemented method of claim 1, further comprising modeling a confidence interval for each of the oil flow rate, gas flow rate, and water flow rate.

7. The computer-implemented method of claim 1, further comprising:
determining that the oil flow rate, the gas flow rate, or the water flow rate that was modeled is unreliable; and
providing a recommendation that a new well test is needed based on the determination.

8. The computer-implemented method of claim 7, wherein the determining that the oil flow rate, the gas flow rate, or the water flow rate that was modeled is unreliable is based on information from one or more process historians.

9. The computer-implemented method of claim 7, further comprising determining that the new well test should occur prior to new well test for other wells associated with the asset.

10. The computer-implemented method of claim 1, further comprising:
determining that one or more parameters from the one or more sensors at the is missing, corrupt, out of an expected range, or combinations therein; and
removing the one or more parameters that were determined to be missing, corrupt, out of an expected range as an input to the ensemble of data-driven models.

11. The computer-implemented method of claim 1, further comprising:
determining that the oil flow rate, the gas flow rate, or the water flow rate that was modeled does not match with physical data obtained at the well;
modifying the oil flow rate, the gas flow rate, or the water flow rate based on the physical data that was obtained.

12. The computer-implemented method of claim 1, further comprising:
determining that one or more of the parameters obtained during the well test is not valid; and
automatically producing a new well model based on the one or more of the parameters that are valid.

13. The computer-implemented method of claim 1, further comprising:
determining that another well test is being performed for another well associated with the asset during the well test; and
dividing the total flow rates for the asset for the well and the another well that are undergoing well tests.

14. The computer-implemented method of claim 1, wherein both the outputting occurs at different time periods.

15. The computer-implemented method of claim 1, further comprising automatically producing updated water flow rate, oil flow rate, and gas flow rate estimates after determining that the one or more parameters are outside of a valid date range.

16. A system comprising:
one or more processors; and
a non-transitory computer readable medium comprising instructions that cause the one or more processors to perform a method for independently modeling a water flow rate, an oil flow rate, and a gas flow rate using an ensemble of data-driven computer models, the method comprising:
automatically obtaining one or more parameters of the well as measured by one or more sensors at one or more of a well bore, a well head, and one or more flow lines to a separator associated with the well during a well test;
using the ensemble of data-driven computer models to independently model the water flow rate, the oil flow rate, and the gas flow rate based on the one or more parameters;
evaluating each data-driven computer model of the ensemble of data-driven computer models based on historic, current, or both historic and current conditions;
selecting a subset of data-driven computer models from the ensemble of data-driven computer models that were evaluated to independently model the water flow rate, the oil flow rate, and the gas flow rate based on the one or more parameters;
modeling each of the water flow rate, the oil flow rate, and the gas flow rate independently using the subset of data-driven computer models; and
automatically reconciling each of the water flow rate, the oil flow rate, and the gas flow rate that was independently modeled for the well with a total flow rate obtained at the asset;
outputting each of the water flow rate, the oil flow rate, and the gas flow rate based on the modeling and outputting the each of the water flow rate, the oil flow rate, and the gas flow rate based on the reconciling.

17. The system of claim 16, wherein the one or more parameters comprise one or more of: a well head pressure that is measured at a discharge portion of a well before a choke, a well head temperature that is measured at a discharge portion of a well before a choke, a casing pressure that is a measure of a pressure on a casing of a well caused by injected gas in a gas lift injected well, a flow line pressure is a measure of pressure of a production measured after a choke, and an amount of choke.

18. The system of claim 16, wherein the ensemble of data-driven computer models comprise one or more of: a neural network models, non-linear regression models, fuzzy rule-based models, genetic algorithms, evolutionary algorithms, chaos theory, non-linear dynamics, and support vector machines.

19. The system of claim 16, wherein the one or more processors are further operable to perform the method comprising applying one or more statistical algorithms to prepare the one or more parameters for modeling.

20. The system of claim 16, wherein the one or more processors are further operable to perform the method comprising determining that one or more values in the one or more parameters is outside a predetermined threshold and removing the one or more values that were determined to be outside the predetermined threshold.

21. The system of claim 16, wherein the one or more processors are further operable to perform the method comprising modeling a confidence interval for each of the oil flow rate, gas flow rate, and water flow rate.

22. The system of claim 16, wherein the one or more processors are further operable to perform the method comprising:
determining that the oil flow rate, the gas flow rate, or the water flow rate that was modeled is unreliable; and
providing a recommendation that a new well test is needed based on the determination.

23. The system claim 22, wherein the determining that the oil flow rate, the gas flow rate, or the water flow rate that was modeled is unreliable is based on information from one or more process historians.

24. The system of claim 16, wherein the one or more processors are further operable to perform the method further comprising determining that the new well test should occur prior to new well test for other wells associated with the asset.

25. The system of claim 16, wherein the one or more processors are further operable to perform the method comprising:
determining that one or more parameters from the one or more sensors at the is missing, corrupt, out of an expected range, or combinations therein; and
removing the one or more parameters that were determined to be missing, corrupt, out of an expected range as an input to the ensemble of data-driven models.

26. The system of claim 16, wherein the one or more processors are further operable to perform the method comprising:
determining that the oil flow rate, the gas flow rate, or the water flow rate that was modeled does not match with physical data obtained at the well;
modifying the oil flow rate, the gas flow rate, or the water flow rate based on the physical data that was obtained.

27. The system of claim 16, wherein the one or more processors are further operable to perform the method comprising:
determining that one or more of the parameters obtained during the well test is not valid; and
automatically producing a new well model based on the one or more of the parameters that are valid.

28. The system of claim 16, further comprising:
determining that another well test is being performed for another well associated with the asset during the well test; and
dividing the total flow rates for the asset for the well and the another well that are undergoing well tests.

29. The system of claim 16, wherein both the outputting occurs at different time periods.

30. The system of claim 16, wherein the one or more processors are further operable to perform the method comprising automatically producing updated water flow rate, oil flow rate, and gas flow rate estimates after determining that the one or more parameters are outside of a valid date range.

31. A non-transitory computer readable storage medium comprising instructions that cause one or more processors to perform a method for independently modeling a water flow rate, an oil flow rate, and a gas flow rate using an ensemble of data-driven computer models, the method comprising:
automatically obtaining one or more parameters of the well as measured by one or more sensors at one or more of a well bore, a well head, and one or more flow lines to a separator associated with the well during a well test;
using the ensemble of data-driven computer models to independently model the water flow rate, the oil flow rate, and the gas flow rate based on the one or more parameters;
evaluating each data-driven computer model of the ensemble of data-driven computer models based on historic, current, or both historic and current conditions;
selecting a subset of data-driven computer models from the ensemble of data-driven computer models that were evaluated to independently model the water flow rate, the oil flow rate, and the gas flow rate based on the one or more parameters;
modeling each of the water flow rate, the oil flow rate, and the gas flow rate independently using the subset of data-driven computer models; and
automatically reconciling each of the water flow rate, the oil flow rate, and the gas flow rate that was independently modeled for the well with a total flow rate obtained at the asset;
outputting each of the water flow rate, the oil flow rate, and the gas flow rate based on the modeling and outputting the each of the water flow rate, the oil flow rate, and the gas flow rate based on the reconciling.

32. The non-transitory computer readable storage medium of claim 31, further comprising determining that one or more values in the one or more parameters is outside a predetermined threshold and removing the one or more values that were determined to be outside the predetermined threshold.

33. The non-transitory computer readable storage medium of claim 31, further comprising modeling a confidence interval for each of the oil flow rate, gas flow rate, and water flow rate.
